(19) United States
(12) Patent Application Publication
(10) Pub. No.: US 2023/0060842 A1
(43) Pub. Date: Mar. 2, 2023

(54) METHOD FOR DRAWING AN OPTICAL FIBER USING ROD-IN CYLINDER TECHNIQUE

(71) Applicant: Sterlite Technologies Limited, Gurgaon (IN)

(72) Inventor: Nivedita Prasad, Gurgaon (IN)

(21) Appl. No.: 17/553,554

(22) Filed: Dec. 16, 2021

(30) Foreign Application Priority Data
Aug. 27, 2021 (EP) 20748219.1

(51) Int. Cl. C03B 37/027; C03B 37/012; G02B 6/02; C03C 13/04

(52) U.S. Cl. CPC C03B 37/02763; C03B 37/01205; C03B 37/01282; G02B 6/02395; C03C 13/046; C03B 2201/12; C03B 2205/08; C03C 2213/00

(57) ABSTRACT

A method for drawing an optical fibre from an optical fibre preform with a core section, a cladding section, a first gap and a second gap. The optical fibre preform is attached to an optical fibre draw tower through a handle. In addition, the optical fibre preform is connected to a vacuum system to supply and remove gas from the first gap and the second gap. Moreover, the gas is supplied to create a thermal barrier between the core section and the cladding section during heating of the optical fibre preform. Further, the optical fibre preform is heated inside a heating furnace to draw the optical fibre from the optical fibre preform.

### FIELD OF THE INVENTION

Embodiments of the present invention relate to the field of glass manufacturing. More particularly, the present disclosure relates to a method for drawing an optical fibre using rod-in-cylinder technique.

### BACKGROUND

Optical fibre communication has revolutionized the telecommunication industry in the past few years. The use of optical fibre cables has helped to bridge the gap between the distant places around the world. One of the basic components of the optical fibre cable is an optical fibre. The optical fibre is responsible for carrying vast amounts of information from one place to another. There are different methods for manufacturing glass bodies and optical fibres. These methods are primarily adopted to manufacture glass preform and optical fibre.

One such method to draw the optical fibre preform is the Rod-in-Cylinder (RIC) process. In general, RIC process refers to a manufacturing process of a large-sized fibre preform by inserting a core rod assembly into a large cylindrical tube. The cylindrical tube is heated and collapsed onto the core rod assembly. Typically, the cylindrical tube is a pure silica tube. Accordingly, the optical fibre is drawn from the optical fibre preform using conventional drawing methods.

Alternatively, the optical fibre is drawn directly from the consolidated assembly of core rod and the cylindrical tube by directly placing it on a draw tower. It is desirable to draw an optical fibre with similar materials for e.g. for core calcium aluminium silicate (CAS) with higher refractive index composition and for clad composition with lower refractive index compared to core.

The refractive index compositions are maintained by adjusting the concentration of silica and adding dopants like fluorine and/or other down-dopants. Similar core and clad with a refractive index difference will have the same thermal, mechanical, and chemical properties which will lead to reduced losses and more suitability towards fibre drawing.

However, due to similar thermal properties, at high temperatures the core diffuses with the clad and also, they intermix. This mixing will result in change in refractive index profile which will affect the waveguide properties. So, there is a need to prevent the diffusion or mixing between the core and the cladding.

Secondly, when there is a huge difference between the melting points of core and clad, and the core has the lower melting point, it is preferable to keep the core and the clad at two different temperatures while drawing. It is not possible with the current arrangements in the draw tower especially while drawing a low attenuation material like CAS as core and higher melting material like silica as clad.

Thus in light of the above stated discussion, there is a need to develop an advanced method for manufacturing an optical fibre that overcomes the above stated disadvantages.

### SUMMARY OF THE INVENTION

Embodiments of the present invention relates to a method for drawing an optical fibre from an optical fibre preform comprising steps of feeding the optical fibre preform into a heating furnace, heating the optical fibre preform inside the heating furnace at a high temperature, supplying gas into the first gap and second gaps of the optical fibre preform, and drawing the optical fibre preform. In particular, the optical fibre preform is fed with facilitation of top-feed unit. Particularly, the optical fibre preform comprises a core section, a cladding section, a first gap, and a second gap. Moreover, heating of the optical fibre preform enables fusion between the core section and the cladding section. Furthermore, the gas is supplied into the first gap of the optical fibre preform and the second gap of the optical fibre preform with facilitation of a vacuum system. Additionally, the drawing of the optical fibre preform results into a drawn optical fibre preform. Particularly, the drawn optical fibre preform comprises a drop-end. The optical fibre preform for drawing the optical fibre comprises a core section, a cladding section, a first gap, and a second gap. In particular, the core section is an inner part of the optical fibre preform. Particularly, the cladding section is an outer part of the optical fibre preform. Moreover, the first gap of the optical fibre preform and the second gap of the optical fibre preform corresponds to a space between the core section of the optical fibre preform and the cladding section of the optical fibre preform. Furthermore, the optical fibre formed is an ultra-low loss optical fibre with low attenuation and bending losses.

In accordance with an embodiment of the present invention, the vacuum system supplies gas to the first gap of the optical fibre preform with facilitation of a first gas inlet of the optical fibre preform.

In accordance with an embodiment of the present invention, the vacuum system supplies gas to the second gap of the optical fibre preform with facilitation of a second gas inlet of the optical fibre preform.

In accordance with an embodiment of the present invention, gas used for supplying to the first gap of the optical fibre preform and the second gap of the optical fibre preform is a helium gas.

In accordance with an embodiment of the present invention, a first gas outlet and a second gas outlet are positioned on a top of the optical fibre preform.

In accordance with an embodiment of the present invention, the helium gas creates a thermal barrier between the core section of the optical fibre preform and the cladding section of the optical fibre preform during heating of the optical fibre preform in the heating furnace.

In accordance with an embodiment of the present invention, the core section of the optical fibre preform is exposed to lower temperature as compared to the cladding section of the optical fibre preform.

In accordance with an embodiment of the present invention, the core section of the optical fibre preform is made of calcium aluminium silicate.

In accordance with an embodiment of the present invention, the optical fibre formed is an ultra-low loss optical fibre with low attenuation and bending losses.

In accordance with an embodiment of the present invention, the core section is an inner part of the optical fibre preform, wherein the cladding section is an outer part of the optical fibre preform.

In accordance with an embodiment of the present invention, the drop-end of the drawn optical fibre preform falls under gravity through a hole at bottom portion of the heating furnace, and heating of the drawn optical fibre preform results into the optical fibre.

In accordance with an embodiment of the present invention, a vacuum system supplies gas to the second gap of the optical fibre preform with facilitation of a second gas inlet of the optical fibre preform.

The foregoing objectives of the present invention are attained by employing a method for drawing an optical fibre using rod-in-cylinder technique.

### BRIEF DESCRIPTION OF THE DRAWINGS

So that the manner in which the above recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic representation illustrating an optical fibre draw tower in accordance with one embodiment of the present invention;

FIG. 2 is a schematic representation illustrating an optical fibre draw tower in accordance with another embodiment of the present invention

FIG. 3 is a flow chart illustrating a method of drawing the optical fibre from a glass preform in accordance with an embodiment of the present invention.

### ELEMENT LIST

Optical fibre draw tower—100
Optical fibre preform—102
Longitudinal axis—104
Core section—106
Cladding section—108
First Gap—110
Second Gap—112
Heating Furnace—114
First Gas Inlet—116
Second Gas Inlet—118
First Gas Outlet—120
Second Gas Outlet—122

The method and the optical fibre preform are illustrated in the accompanying drawings, throughout which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DETAILED DESCRIPTION OF THE INVENTION

The present invention relates to an ultra low loss optical fibre and a method of manufacture thereof.

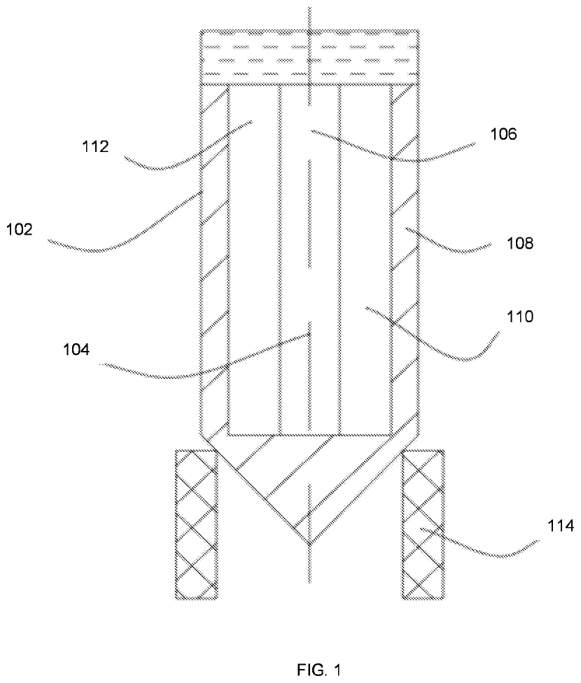

The principles of the present invention and their advantages are best understood by referring to FIG. 1 to FIG. 3. In the following detailed description numerous specific details are set forth in order to provide a thorough understanding of the embodiment of invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The following brief definition of terms shall apply throughout the present invention:

Optical fibre is used for transmitting information as light pulses from one end to another. In addition, optical fibre is a thin strand of glass or plastic capable of transmitting optical signals. Further, optical fibre allows transmission of information in the form of optical signals over long distances. Furthermore, optical fibre is used for a variety of purposes. The variety of purposes includes telecommunications, broadband communications, medical applications, military applications and the like.

Refractive index of a material is the ratio of speed of light in vacuum to speed of light in material.

Glass is a non-crystalline amorphous solid, often transparent and has widespread applications. In addition, the applications of glass ranges from practical usage in daily life, technological usage, and decorative usage. Further, most common type of glass is silicate glass formed of chemical compound silica.

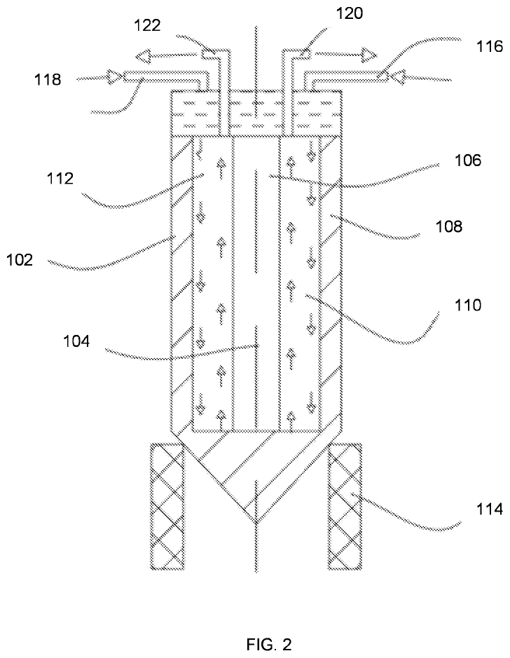

Referring to FIG. 1 and FIG. 2 illustrating an optical fibre draw tower in accordance with one or more embodiments of the present invention. The various components of the optical draw tower 100 collectively enable a method for drawing of an optical fibre. In particular, the optical draw tower 100 includes an optical fibre preform 102, a core section 106, a cladding section 108, a first gap 110 a second gap 112, and a heating furnace 114. Moreover, the optical draw tower 100 includes a first gas inlet 116, a second gas inlet 118, and a first gas outlet 120. Further, the optical fibre draw tower 100 includes a vacuum system.

The optical fibre draw tower 100 is not a rectangular setup. In particular, the optical fibre draw tower 100 is a circular setup. The optical fibre draw tower 100 is configured to enable drawing of the optical fibre from the optical fibre preform 102. The optical fibre preform 102 is an ultra-low loss glass preform.

In accordance with an embodiment of the present embodiment, the ultra-low loss glass preform is manufactured to produce an ultra-low loss optical fibre using the optical fibre draw tower 100. Particularly, the optical fibre preform 102 is manufactured using RIC method. In general, RIC method corresponds to Rod-in-Cylinder method for manufacturing optical fibre preform. Moreover, Rod-in-Cylinder method utilizes core rod and cladding tube. The core rod is inserted into cladding tube such that cladding tube is fused with core rod at high temperature in a furnace to obtain optical fibre preform. Subsequently, optical fibre is drawn from optical fibre preform.

In accordance with an embodiment of the present embodiment, RIC method utilizes online RIC method along with a convectional cooling approach to obtain the optical fibre preform 102.

In accordance with an embodiment of the present embodiment, the optical fibre draw tower 100 is a mechanical system or apparatus for heating of the optical fibre preform 102 and drawing the optical fibre from the optical fibre preform 102 of desired characteristics.

In accordance with an embodiment of the present embodiment, the optical fibre preform 102 is attached to the optical fibre draw tower 100 through a handle. In another embodiment of the present disclosure, the optical fibre preform 102 is attached to the optical fibre draw tower 100 using any other suitable component. In general, optical fibre preform is a large cylindrical body of glass having a core structure and a cladding structure. In addition, optical fibre preform is a material used for fabrication of optical fibres. In general, optical fibre is a fibre used for transmitting information as light pulses from one end to another. In addition, optical fibre is a thin strand of glass capable of transmitting optical signals. In addition, optical fibre allows transmission of information in the form of optical signals over long distances. Further, optical fibre is used for a variety of purposes. The variety of purposes includes but may not be limited to telecommunications, broadband communications, medical applications, military applications and the like. The optical fibre preform 102 is the optical fibre in a large form.

In accordance with an embodiment of the present embodiment, the optical fibre preform 102 includes the core section 106 and the cladding section 108. The core section 106 is an inner part of the optical fibre preform 102. The cladding section 108 is an outer part of the optical fibre preform 102. Moreover, the core section 106 and the cladding section 108 are formed during manufacturing stage of the optical fibre preform 102. The core section 106 has refractive index greater than refractive index of the cladding section 108. The core section 106 has higher refractive index than the cladding section 108. The refractive index is maintained as per a desired level based on a concentration of chemicals used for the production of the optical fibre preform 102.

In accordance with an embodiment of the present embodiment, the optical fibre preform 102 is associated with a longitudinal axis 104. The longitudinal axis 104 is an imaginary axis passing through the geometrical centre of the optical fibre preform 102. The core section 106 is a region around the longitudinal axis 104 of the optical fibre preform 102. The core section 106 extends radially outward from the longitudinal axis 104 of the optical fibre preform 102.

In accordance with an embodiment of the present embodiment, the core section 106 corresponds to a cylindrical core rod made of a Calcium Aluminium Silicate (CAS) material. Alternatively, the core section 106 corresponds to a cylindrical core rod made of any suitable material.

In accordance with an embodiment of the present embodiment, the Calcium Aluminium Silicate is obtained in various forms such as molten, glass and powder that is casted as glass or is directly used for making the core and clad of the optical fibre. In particular, the core rod is made from any of the conventional optical fibre manufacturing methods.

In accordance with an embodiment of the present embodiment, the cladding section 108 corresponds to a cladding cylinder made of a silica material. Alternatively, the cladding section 108 corresponds to a cylindrical core rod made of any suitable material. In addition, other materials with higher melting points are used for the cladding section 108. The core rod is placed inside the cladding cylinder such that geometrical centres of the core rod and the cladding cylinder are the same. The present disclosure utilizes a basic idea of the Rod-in-Cylinder technique by placing the core rod inside the cladding cylinder. The optical fibre preform 102 is aligned vertically on the optical fibre draw tower 100 using the handle.

In accordance with an embodiment of the present embodiment, the optical fibre preform 100 includes the first gap 110 and the second gap 112 (as shown in FIG. 1 and FIG. 2). Particularly, the first gap 110 and the second gap 112 correspond to a space between the core section 106 and the cladding section 108. Moreover, the first gap 110 and the second gap 112 are utilized to create a thermal barrier between the core section 106 and the cladding section 108 during heating of the optical fibre preform 102. Furthermore, the optical fibre preform 102 includes a convective cooling system. The convective cooling system is configured to supply and remove gas inside the first gap 110 and the second gap 112. The gas is supplied to create a thermal barrier between the core section 106 and the cladding section 108.

In accordance with an embodiment of the present embodiment, the optical fibre draw tower 100 utilizes the vacuum system as a simple rotary vane pump. Alternatively, the optical fibre draw tower 100 utilizes any other suitable system of the like. The vacuum system consists of multiple tubes or pipes that enable supply of gas in the first gap 110 and the second gap 112. The first gap 110 and the second gap 112 is a part of a single gap that is circular in shape. Also, the supplied gas is removed from the first gap 110 and the second gap 112 through the multiple tubes or pipes. The multiple tubes or pipes are configured to be attached to the optical fibre preform 102 through any suitable attachment means. The multiple tubes or pipes include the first gas inlet 116, the second gas inlet 118, the first gas outlet 120 and the second gas outlet 122. The first gas inlet 116 is provided on a first side of the optical fibre preform 102. The first side corresponds to a side where the first gap 110 is located. The second gas inlet 118 is provided on a second side of the optical fibre preform 102. The second side corresponds to a side where the second gap 112 is located.

In accordance with an embodiment of the present embodiment, the first gas inlet 116 and the second gas inlet 118 are attached to the optical fibre preform 102 on the corresponding first side and the second side through any suitable means. The first gas inlet 116 and the second gas inlet 118 are provided on top of the optical fibre preform 102. The first gas inlet 116 is configured to supply gas inside the first gap 110. In addition, the second gas inlet 118 is configured to supply gas inside the second gap 112.

The first gas outlet 120 is provided on the first side of the optical fibre preform 102. The first gas outlet 120 is provided adjacent to the first gas inlet 116. In addition, the first side corresponds to a side where the first gap 110 is located. The second gas outlet 122 is provided on the second side of the optical fibre preform 102. The second gas outlet 122 is provided adjacent to the second gas inlet 116. In addition, the second side corresponds to a side where the second gap 112 is located.

In accordance with an embodiment of the present embodiment, the first gas outlet 120 and the second gas outlet 122 are attached to the optical fibre preform 102 on the corresponding first side and the second side through any suitable means. The first gas outlet 120 and the second gas outlet 122 are provided on the top of the optical fibre preform 102. The first gas outlet 120 is configured to remove gas that is supplied inside the first gap 110 through the first gas inlet 116. In addition, the second gas inlet 118 is configured to remove gas that is supplied inside the second gap 112 through the second gas inlet 118. The gas is supplied simultaneously in the first gap 110 and the second gap 112 during heating of the optical fibre preform 102 inside the heating furnace 114 of the optical fibre draw tower 100.

In accordance with an embodiment of the present embodiment, the method for drawing the optical fibre from the optical fibre preform 102 utilizes a convection cooling approach in RIC method. The optical fibre preform 102 is fed to the heating furnace 114 of the optical fibre draw tower 100. The optical fibre preform 102 is fed to the heating furnace 114 using a top-feed unit. The top-feed unit is a part of the optical fibre draw tower 100. The optical fibre preform 102 includes the core section 106 and the cladding section 108. The cladding section 108 is made of a material having a melting temperature higher than that of the material from which the core section 106 is made.

The optical fibre preform 102 is heated inside the heating furnace 114 at a high temperature. The optical fibre preform 102 is heated to fuse the cladding section 108 with the core section 106. The vacuum system simultaneously supplies gas through the first gas inlet 116 in the first gap 110. The vacuum system simultaneously supplies gas through the second gas inlet 118 in the second gap 112.

In an embodiment of the present disclosure, supplied gas is helium gas. Alternatively, the supplied gas is any suitable gas. The first gas inlet 116 and the second gas inlet 118 is connected through any suitable gas as an input.

The gas is supplied during heating of the optical fibre preform 102 in the heating furnace 114. The gas is removed simultaneously from the first gap 110 and the second gap 112 using the vacuum system. The gas is supplied to create a thermal barrier between the core section 106 and the cladding section 108 during heating of the optical fibre preform 102 in the heating furnace 114. The thermal barrier ensures that the core section 106 is exposed to a lower temperature as compared to the cladding section 108. Also, the thermal barrier ensures that the core section 106 does not melt and flow before the cladding section 108 gets softened.

Furthermore, the method enables drawing of a high quality optical fibre from the optical fibre preform 102. The cladding section 108 melts and fuses with the core section 106. The drop end of the optical fibre preform 102 begins to fall under gravity through a hole in a bottom portion of the heating furnace 114. In addition, the optical fibre is drawn from the optical fibre preform 102. In general, drawn optical fibre is fed through a cooling chamber and diameter measurement is performed. Further, other operations like coating is performed based on requirement and application for which optical fibre is required. The drawn optical fibre is an ultra-low loss optical fibre having low attenuation and bending losses.

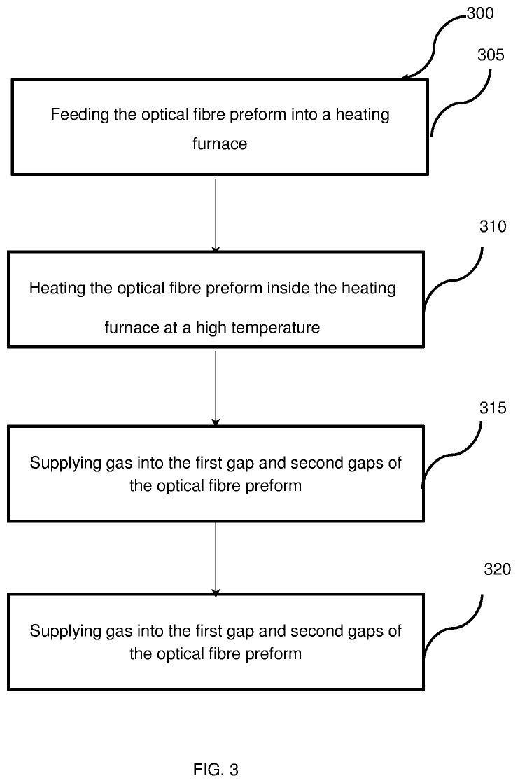

FIG. 3 is a flow chart illustrating a method of drawing an optical fibre from a glass preform in accordance with an embodiment of the present invention. Method 300 starts at step 305, and proceeds to steps 310, and 315.

At step 305, the optical fibre preform is fed into a heating furnace. In particular, the optical fibre preform is fed with facilitation of top-feed unit. Moreover, the optical fibre preform comprises a core section, a cladding section, a first gap, and a second gap.

At step 310, the optical fibre preform is heated inside the heating furnace at a high temperature. Particularly, heating the optical fibre preform enables fusion between the core section and the cladding section.

At step 315, the gas is supplied into the first gap and second gaps of the optical fibre preform. In particular, the gas is supplied into the first gap of the optical fibre preform and the second gap of the optical fibre preform with facilitation of a vacuum system.

At step 320, the optical fibre preform is drawn. Particularly, the drawing of the optical fibre preform results into a drawn optical fibre preform. Particularly, the drawn optical fibre preform comprises a drop-end.

The present invention provides a method for drawing an optical fibre having core region made of Ultra-low loss material and clad region made of silica material using Rod-in-Cylinder technique to utilize convection cooling approach and to prevent diffusion between the core region and the clad region

The foregoing descriptions of pre-defined embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. A method for manufacturing an optical fibre from a glass preform comprising steps of:
placing a powdery substance compactly inside a fluorine doped tube, wherein the powdery substance is used to form a core section of the glass preform, wherein the fluorine doped tube forms a cladding section of the glass preform,
sintering the fluorine doped tube filled with the powdery substance, wherein the powdery substance solidifies and adheres smoothly with the fluorine doped tube to form the glass preform; and
drawing the optical fibre from the glass preform, wherein the glass preform is heated at high temperature to draw the optical fibre.

2. The method of manufacturing as claimed in claim 1, wherein the powdery substance forms a core section of the glass preform and a fluorine doped tube forms a cladding section of the glass preform.

3. The method of manufacturing as claimed in claim 1, wherein the powdery substance corresponds to Calcium Aluminium Silicate (CAS) powder.

4. The method of manufacturing as claimed in claim 2, wherein the powdery substance has size in a range of about 30 microns to 50 microns.

5. The method of manufacturing as claimed in claim 1, wherein the fluorine doped tube has diameter of about 44 millimeter.

6. The method of manufacturing as claimed in claim 1, wherein the fluorine doped tube is sintered at temperature in a range of about 1500 degree Celsius to 1600 degree Celsius.

7. The method of manufacturing as claimed in claim 1, wherein the fluorine doped tube is of hollow cylindrical shape.

8. The method of manufacturing as claimed in claim 1, wherein the method comprises heating of glass preform inside a furnace at high temperature to draw the optical fibre.

9. The method of manufacturing as claimed in claim 1, wherein the method is a powder-in-tube technique.

10. The method of manufacturing as claimed in claim 1, wherein a refractive index of the core section is greater than the refractive index of the cladding section.

11. An optical fibre drawn from a glass preform comprising:
a core section of the glass preform defined as a region around the longitudinal axis; wherein the core section extends radially outward from the longitudinal axis of the optical fibre preform
a cladding section of the glass preform circumferentially surrounds the core section.

12. The optical fibre as claimed in claim 11, wherein the core section formed by a powdery substance.

13. The optical fibre as claimed in claim 11, wherein the cladding section is formed by a fluorine doped tube.

14. The optical fibre as claimed in claim 12, wherein the powdery substance corresponds to Calcium Aluminium Silicate (CAS) powder.

15. The optical fibre as claimed in claim 14, wherein the powdery substance has size in a range of about 30 microns to 50 microns.

16. The optical fibre as claimed in claim 13, wherein the fluorine doped tube has diameter of about 44 millimeter.

17. The optical fibre as claimed in claim 16, wherein the fluorine doped tube is sintered at temperature in range of about 1500 degree Celsius to 1600 degree Celsius.

18. The optical fibre as claimed in claim 17, wherein the fluorine doped tube is of hollow cylindrical shape.

19. The optical fibre as claimed in claim 11, wherein the glass preform is heated inside a furnace at high temperature to draw the optical fibre.

20. The optical fibre as claimed in claim 11, wherein a refractive index of the core section is greater than the refractive index of the cladding section.
